(19) United States
(12) Patent Application Publication
(10) Pub. No.: US 2009/0183915 A1
(43) Pub. Date: Jul. 23, 2009

(54) ONBOARD INTERIOR LIGHTING SYSTEM

(76) Inventor: Yasuo SUZUKI, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/353,532

(22) Filed: Jan. 14, 2009

(30) Foreign Application Priority Data
Jan. 22, 2008 (JP) P2008-011588

(51) Int. Cl. H02G 3/00; B60Q 1/26

(52) U.S. Cl. 174/70 R; 362/490

(57) ABSTRACT

An onboard interior lighting system includes: a functional section main body 11 including functional part attachment portions 11a, 11b and an electric wire connecting part PA connecting electric wires Wa; an electric wire protecting cover 1 configured to cover the electric wire connecting part after the electric wires are connected to the electric wire connecting part; and a functional section A arranged on an exterior side of a ceiling board of a vehicle. The functional section main body is one selected from a selection group for which a plurality of mutually-different types of functional section main bodies are provided, the electric wire protecting cover 1 is of only a single type provided commonly for the mutually-different types of functional section main bodies. The electric wire connecting part PA of each type of functional section main body has its common locking counterparts corresponding to the respective lock parts of the electric wire protecting cover 1 of the single type.

### BACKGROUND OF THE INVENTION

1. Field of the Invention

The present invention relates to an onboard interior lighting system provided to a ceiling of a vehicle.

2. Description of the Related Art

Generally speaking, the onboard interior lighting system includes a design section and a functional section combined with each other. The design section is provided on the interior side of a ceiling board (ceiling trim), and the functional section is provided on the exterior side of the ceiling board. The functional section provided on the exterior side of the ceiling board is configured by attaching a bulb and a switch to a resin-made functional section main body, and additionally by connecting electric wires to an electric wire connecting part, as well as subsequently by covering the thus-connected electric wire connecting part with an electric wire protecting cover. This technique is disclosed, for example, in Japanese Patent Application Laid-Open No. 2005-263078 (Patent Document 1).

In this case, the electric wire protecting cover is provided there for the purpose of protecting the electric wire connecting part from external forces applied thereto while wire harnesses are laid out, and thereby of keeping the electric wires stably connected to the electric wire connecting part.

For the functional section, multiple types of products are provided. Out of the multiple types of products, one type of product is selected depending on a vehicle model and grade. These types of products are different from one another depending on what different type of switch and what different type of bulb are attached to each functional section main body, and on what different type of scheme is employed when the switch and the bulb are attached to the functional section main body. In other words, depending on vehicle models and grades, multiple grades and variations are set up for the functional section.

In a conventional practice, an electric wire protecting cover formed in a different shape is used for each type of functional section.

FIGS. 1 to 9 show three types of functional sections. FIGS. 1 to 3 show a structure of a first type of functional section A1. FIGS. 4 to 6 show a structure of a second type of functional section B1. FIGS. 7 to 9 show a structure of a third type of functional section C1.

As shown in FIGS. 1 to 3, the first type of functional section A1 is a functional section with a push switch for a wedge base bulb which is assembled as follows. At first, a wedge base bulb 12 and a push switch unit 13 are attached to a functional section main body 111. Subsequently, electric wires Wa of a flat wire harness W are pressure-contacted to an electric wire connecting part PA1 in the functional section main body 111. Thereafter, the electric wires Wa and the electric wire connecter PA1 are covered with a specialized electric wire protecting cover A2. Afterward, lock parts 105 of the electric wire protecting cover A2 are engaged with lock parts 115 of the electric wire connecting part PA1, respectively.

As shown in FIGS. 4 to 6, the second type of functional section B1 is a functional section with a switch for a boat bulb which is assembled as follows. At first, a boat bulb 22 and a switch unit 23 are attached to a functional section main body 211. Subsequently, electric wires Wa of a flat wire harness W are pressure-contacted to an electric wire connecting part PB1 of the functional section main body 211. Thereafter, the electric wires Wa and the electric wire connecting part PB1 are covered with a specialized electric wire protecting cover B2. Afterward, lock parts 205 of the electric wire protecting cover B2 are engaged with lock parts 215 of the electric wire connecting part PB1, respectively.

As shown in FIGS. 7 to 9, the third type of functional section C1 is a switchless functional section for a wedge base bulb which is assembled as follows. At first, a wedge base bulb 32 is attached to a functional section main body 311. Subsequently, electric wires Wa of a flat wire harness W are pressure-contacted to an electric wire connecting part PC1 of the functional section main body 311. Thereafter, the electric wires Wa and the electric wire connecting part PC1 are covered with a specialized electric wire protecting cover C2 which is integrated with the functional section main body 311 by use of a hinge 302. Afterward, lock parts 305 of the electric wire protecting cover C2 are engaged with lock parts 315 of the electric wire connecting part PC1, respectively.

In the conventional practice, as a specialized component, one type of electric wire protecting cover is provided for each type of functional section. As a result, multiple types of electric wire protecting covers need to be ready in stock. In addition, it is likely that, out of the multiple types of electric wire protecting covers, a wrong type of electric wire protecting cover may be installed on the functional section main body. Furthermore, it is likely that even a right type of electric wire protecting cover may be incorrectly installed on the functional section main body in a case where the electric wire protecting cover has its orientation. Moreover, automatically installing electric wire protecting covers on the respective functional sections is difficult, because each different type of electric wire protecting cover needs its own specialized facility to be assembled (supplied, attached) on the functional section depending on the difference in shape of the electric wire protecting covers.

### SUMMARY OF THE INVENTION

The present invention has been achieved with such points in mind.

It therefore is an object of the present invention to provide an onboard interior lighting system capable of reducing the number of types of parts, and capable of preventing a wrong part assemblage which would otherwise occurs, as well as capable of contributing to an automated part assemblage.

To achieve the object, according to a first aspect of the present invention, there is provided an onboard interior lighting system including: a functional section main body including functional part attachment portions and an electric wire connecting part, electric wires being connected to the functional section main body via the electric wire connecting part; functional parts including a bulb and a switch, and attached respectively to the functional part attachment portions on the functional section main body; an electric wire protecting cover configured to cover the electric wire connecting part after the electric wires are connected to the electric wire connecting part, and thereby to protect connected portions of the respective electric wires; and a functional section arranged on an exterior side of a ceiling board of a vehicle. In the configuration, the functional section main body is one selected from a selection group for which a plurality of mutually-different types of functional section main bodies are provided, the functional parts corresponding to the selected functional section main body are attached to the functional section main body, the electric wire protecting cover is of only a single type provided commonly for the mutually-different types of functional section main bodies; and the electric wire connecting part of each type of functional section main body has its common locking counterparts corresponding to the respective lock parts of the electric wire protecting cover of the single type.

The onboard interior lighting system according to the first aspect of the present invention brings about the following effects, because the system causes the single common type of electric wire protecting cover to be attached to any one of the different types of functional section main bodies. First, the system makes it possible to manage the parts easily, and to reduce the costs. Second, the system no longer causes a wrong type of electric wire protecting cover to be attached to any one of the different types of functional section main bodies. In addition, since the system causes only the single type of electric wire protecting cover to be supplied instead of multiple types of electric wire protecting covers when the system is assembled up, the system enables a part feeder to supply electric wire protecting covers of the single type through its automated operation, and accordingly to enhance the productivity.

A second aspect dependent on the first aspect of the present invention is the onboard interior lighting system, in which the electric wire connecting part of each type of functional section main body has common lock means as its common locking counterparts corresponding to the respective lock parts of the electric wire protecting cover of the single type.

The onboard interior lighting system according to the second aspect of the present invention enables the electric wire protecting cover to be commonly attached to any one of the different types of functional section main bodies only by locking the lock means of the electric wire protecting cover to the common lock means of the electric wire connecting part because the electric wire connecting part of each different type of functional section main body has the common lock means as its common locking counterparts corresponding to the respective lock parts of the electric wire protecting cover of the single type.

A third aspect dependent on any one of the first and second aspects of the present invention is the onboard interior lighting system, in which the electric wire protecting cover has an almost rectangular shape symmetrical with respect to the center line extending in the width direction and with respect to the center line extending in the longitudinal direction.

The onboard interior lighting system according to the third aspect of the present invention makes it possible to attach the electric wire protecting cover to any one of the different types of functional section main bodies with no attention required to be paid to the orientation of the electric wire protecting cover, because the electric wire protecting cover is formed almost rectangular in such a way as to be symmetrical with respect to the center line extending in the width direction and with respect to the center line extending in the longitudinal direction. In addition, the onboard interior lighting system can simplify a part feeder in a case where the part feeder supplies the electric wire protecting cover through its automated operation, because the electric wire protecting cover has no orientation.

A fourth aspect dependent on any one of the first to third aspects of the present invention is the onboard interior lighting system, in which the electric wire connecting part includes multiple press-contacting blades, and in which the electric wire connecting part is configured as an electric wire press-contacting part of a type which press-contacts the electric wires to the press-contacting blades, as well as in which the specifications of the respective press-contacting blades included in the electric wire press-contacting part are unified through all the types of functional section main bodies.

Since the specifications of the press-contacting blades in each of the electric cable connectors are unified, the onboard interior lighting system according to the fourth aspect of the present invention makes it possible to unify the methods of press-contacting the electric wires to the press-contacting blades which methods would otherwise be different from one another depending on the difference among the press-contacting blades into the single method, and to unify the apparatuses for press-contacting the electric wires to the press-contacting blades which apparatuses would otherwise be different from one another depending on the difference among the press-contacting blades into a single apparatus. In addition, the system can enhance the productivity.

### BRIEF DESCRIPTION OF THE ACCOMPANYING DRAWINGS

The above and further objects and novel features of the present invention will more fully appear from the following detailed description when the same is read in conjunction with the accompanying drawings, in which:

FIG. 1 is an exploded, perspective view showing a configuration of a first conventional type of functional section A1;

FIG. 2 is a perspective view showing the configuration of the first conventional type of functional section A1;

FIG. 3 is a plan view showing the configuration of the first conventional type of functional section A1;

FIG. 4 is an exploded, perspective view showing a configuration of a second conventional type of functional section B1;

FIG. 5 is a perspective view showing the configuration of the second conventional type of functional section B1;

FIG. 6 is a plan view showing the configuration of the second conventional type of functional section B1;

FIG. 7 is an exploded, perspective view showing a configuration of a third conventional type of functional section C1;

FIG. 8 is a perspective view showing the configuration of the third conventional type of functional section C1;

FIG. 9 is a plan view showing the configuration of the third conventional type of functional section C1;

FIG. 10 is a perspective view showing a configuration of an electric wire protecting cover which is commonly assembled with mutually-different types of functional sections of the onboard interior lighting system according to the present invention;

FIG. 11 is a perspective view showing a configuration of the backside of the electric wire protecting cover of the onboard interior lighting system according to the present invention;

FIG. 12 is an exploded perspective view showing a configuration of a first type of functional section A;

FIG. 13 is a perspective view showing the configuration of the first type of functional section A;

FIG. 14 is a plan view showing the configuration of the first type of functional section A;

FIG. 15 is an exploded perspective view showing a configuration of a second type of functional section B;

FIG. 16 is a perspective view showing the configuration of the second type of functional section B;

FIG. 17 is a plan view showing the configuration of the second type of functional section B;

FIG. 18 is an exploded, perspective view showing a configuration of a third type of functional section C;

FIG. 19 is a perspective view showing the configuration of the third type of functional section C; and

FIG. 20 is a plan view showing the configuration of the third type of functional section C.

### DETAILED DESCRIPTION OF THE PREFERRED EMBODIMENTS

There will be detailed below the preferred embodiments of the present invention with reference to the accompanying drawings. Like members are designated by like reference characters.

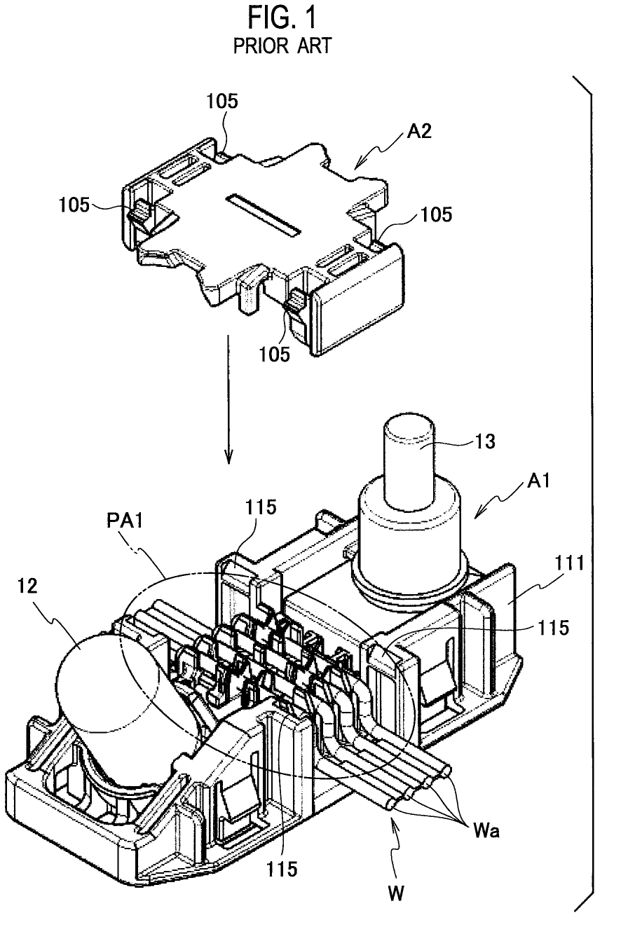

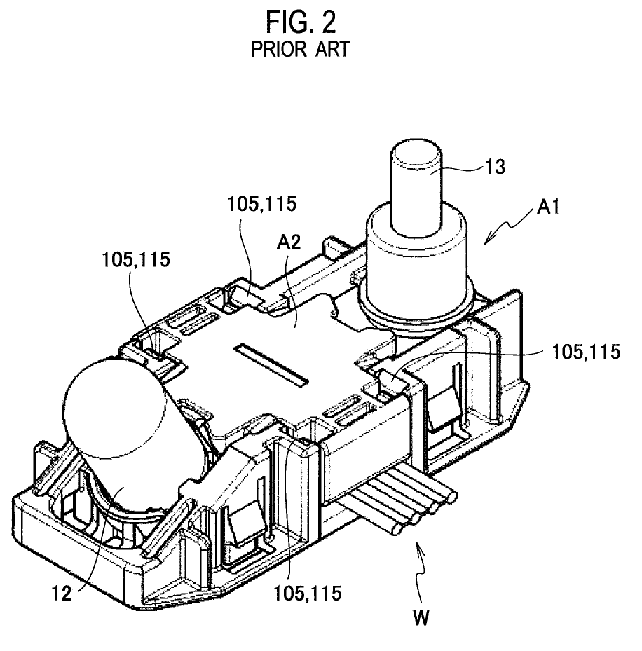

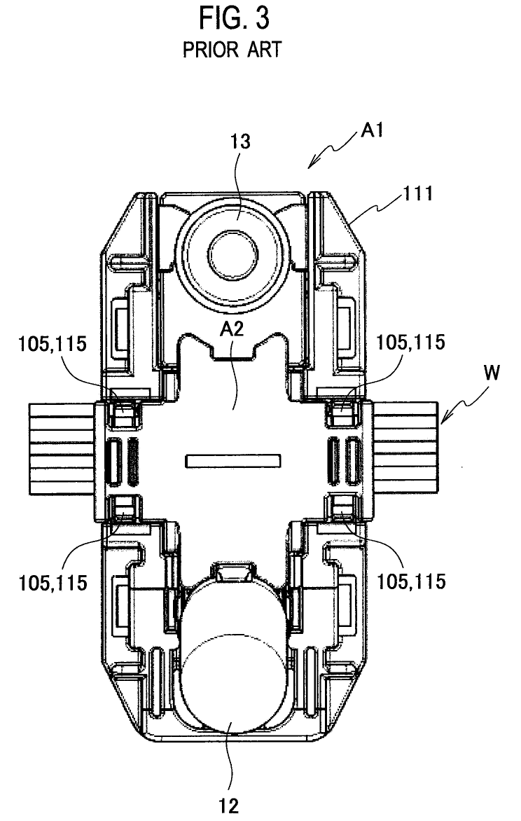

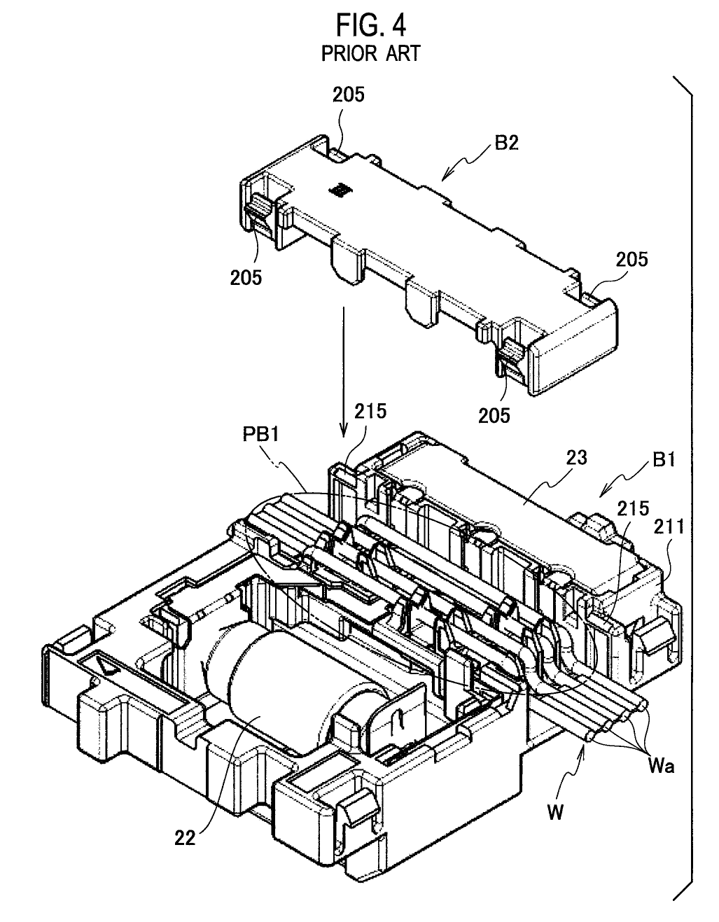

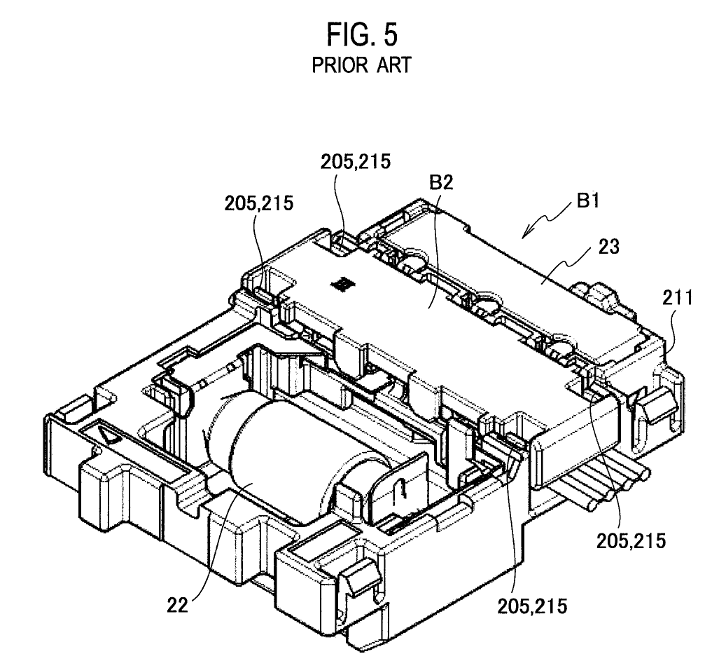

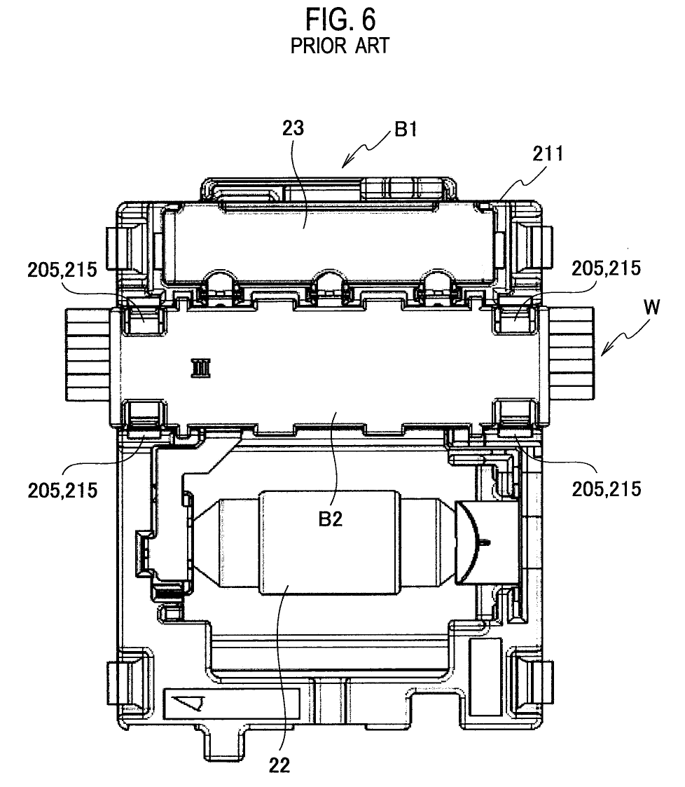

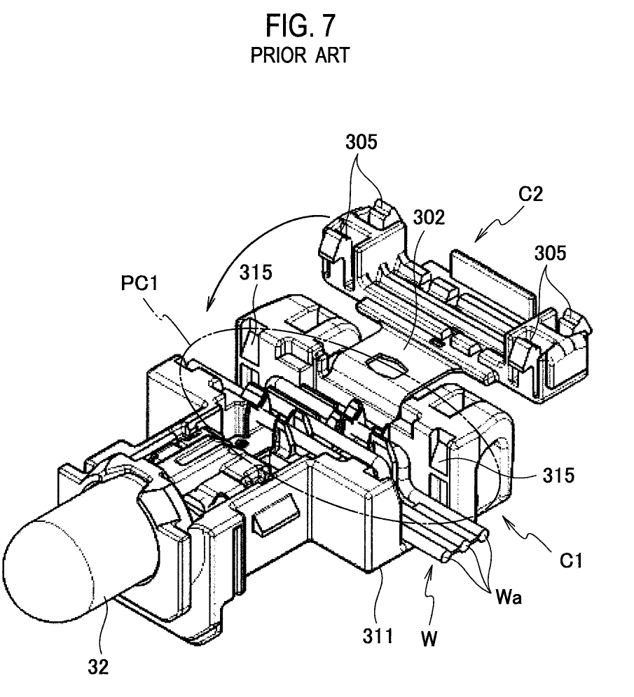

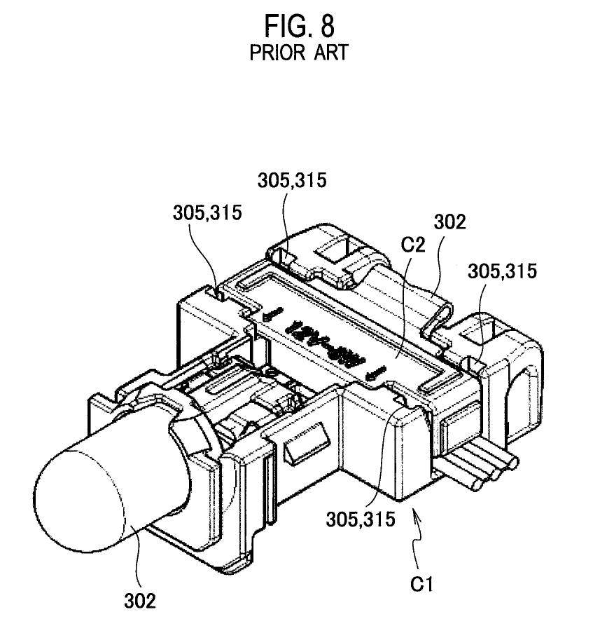

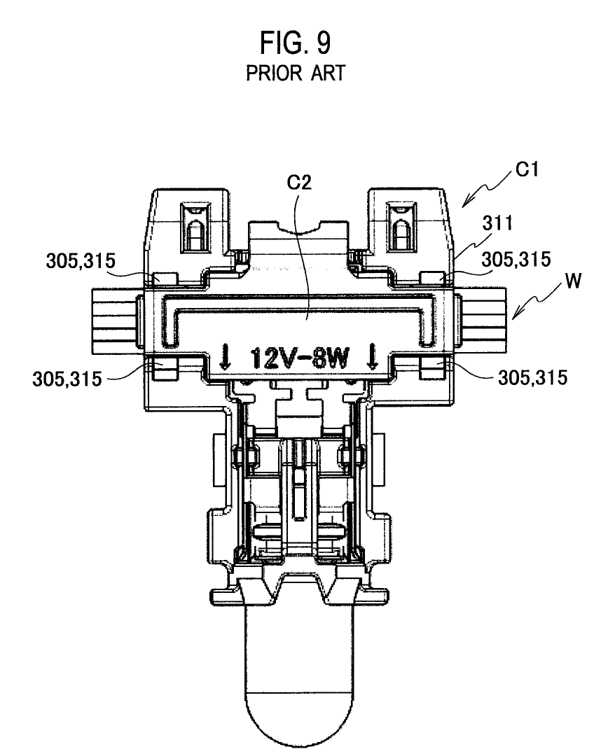

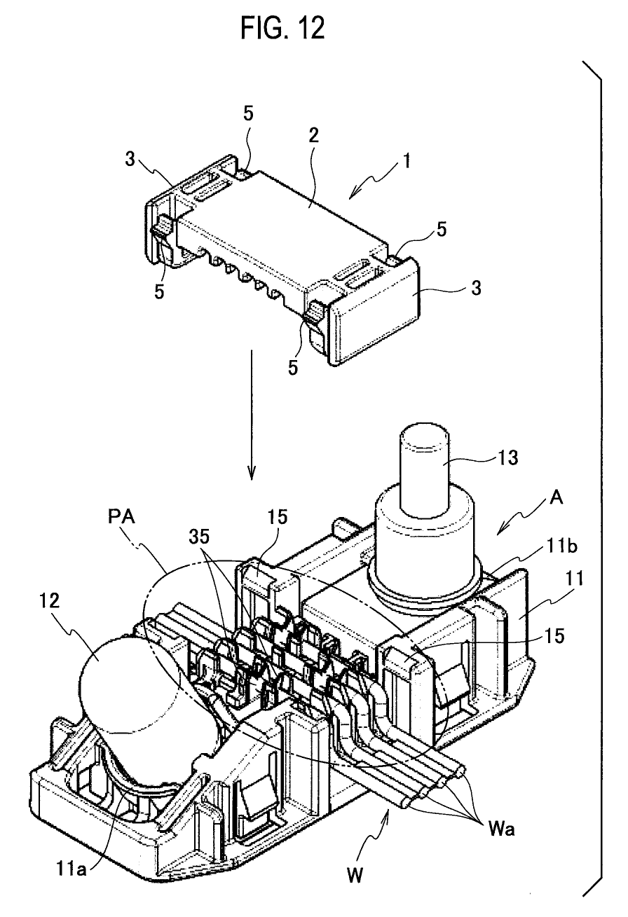

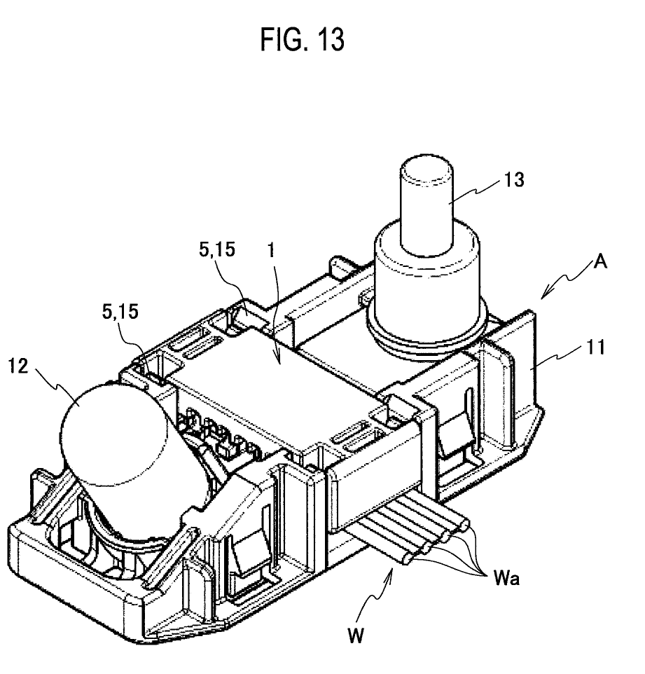

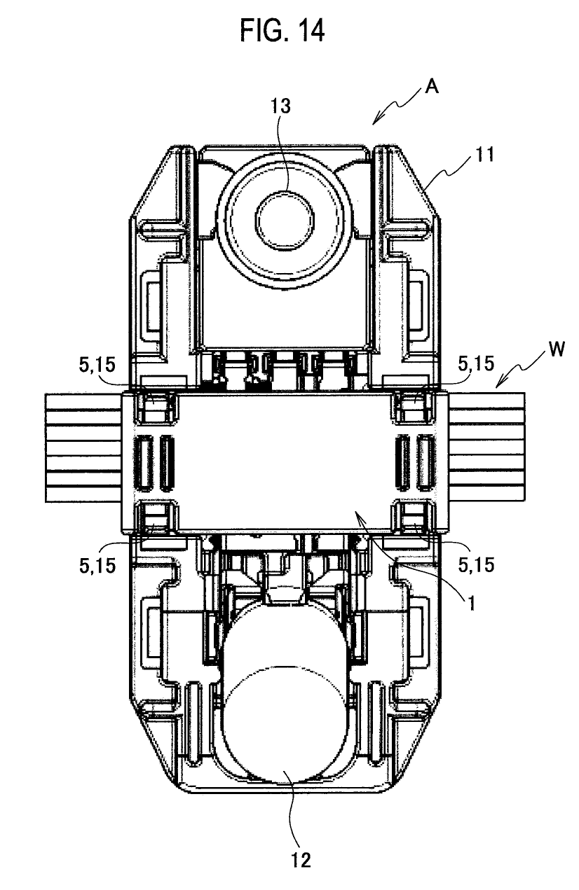

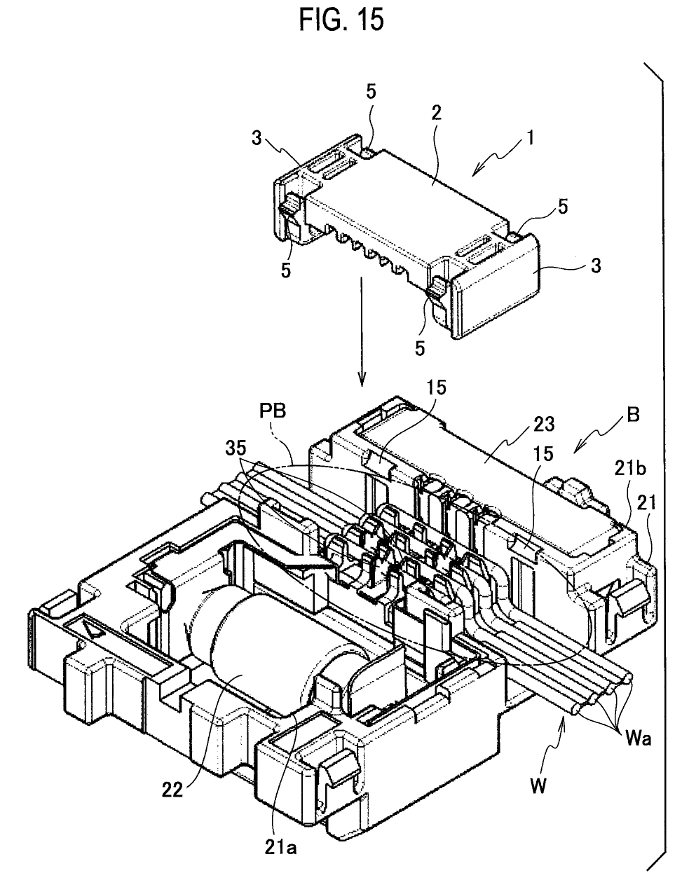

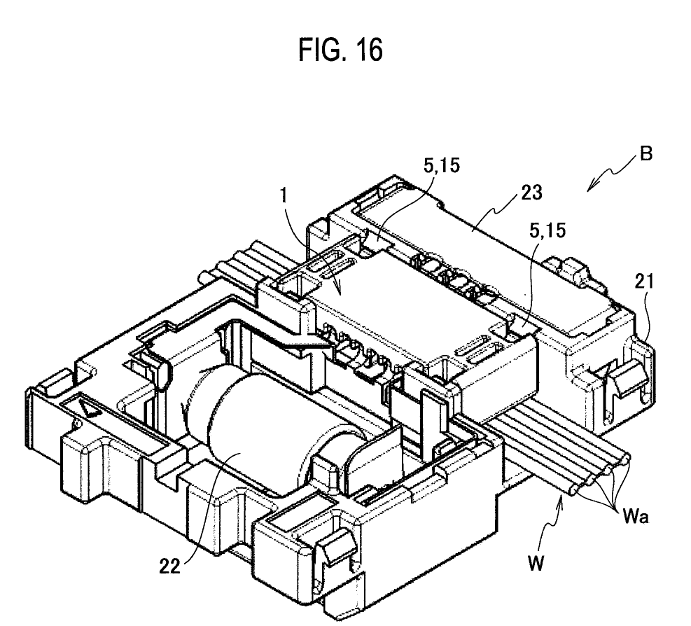

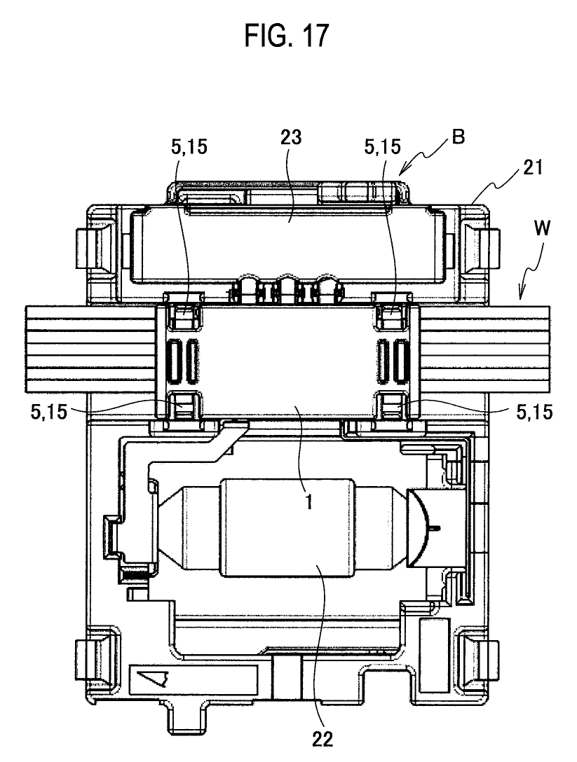

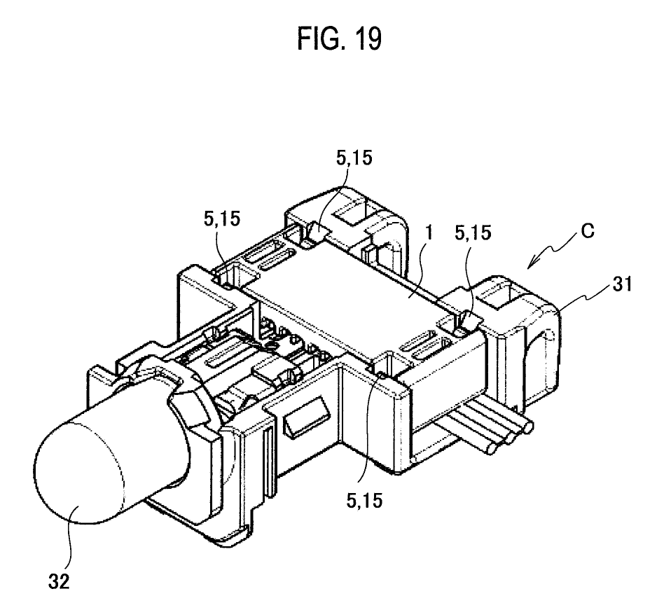

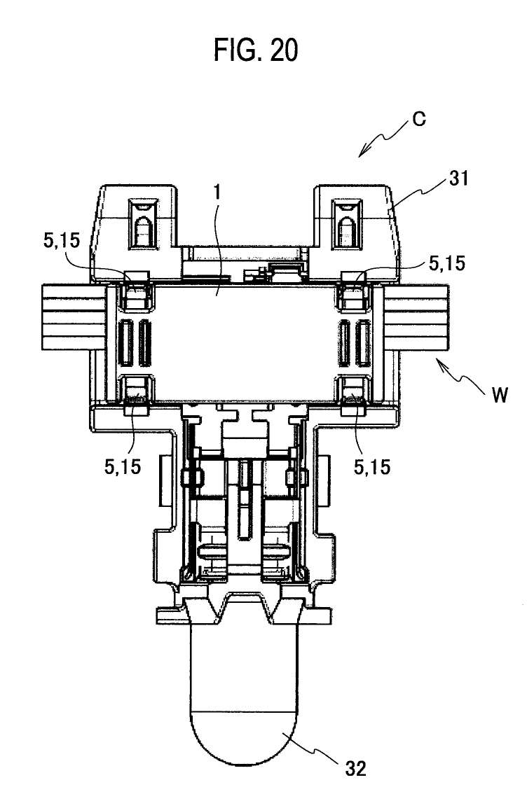

An onboard interior lighting system according to this embodiment is configured by combining a design section and a functional section. The design section is provided on the interior side of a ceiling board (ceiling trim) of a vehicle, and the functional section is provided on the exterior side of the ceiling board. For the functional section, a group of products is provided in order that a suitable one can be selected from multiple types of products depending on a vehicle model, grade and the like. The functional section provided on the exterior side thereof is assembled up by attaching functional parts including a bulb and a switch to a resin-made functional section main body, and subsequently by connecting electric wires to an electric wire connecting part, as well as thereafter by covering the electric wires and the electric wire connecting part with an electric wire protecting cover. In this respect, three types of functional sections shown in FIGS. 12 to 20 are provided, and correspond to the respective three types of functional sections shown in FIGS. 1 to 9.

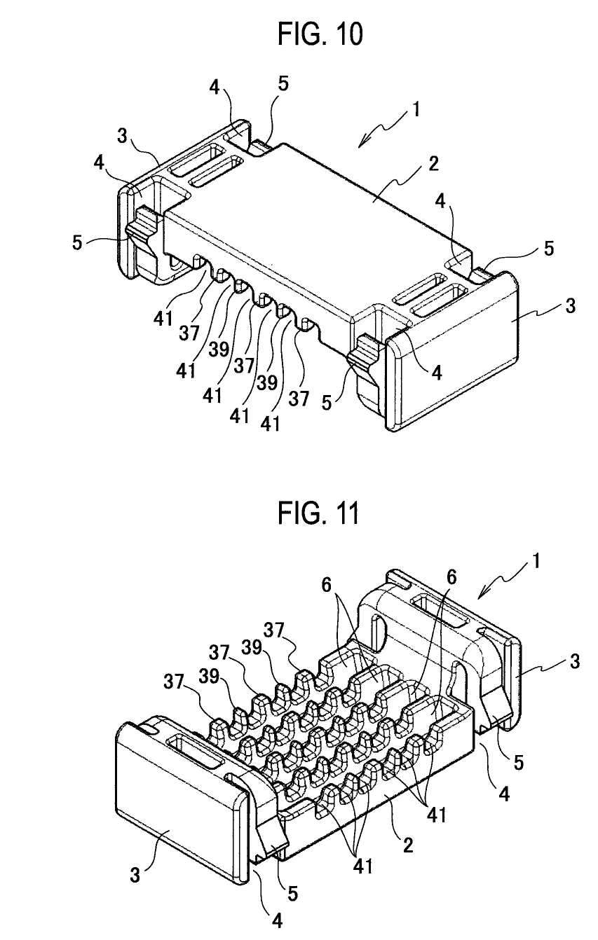

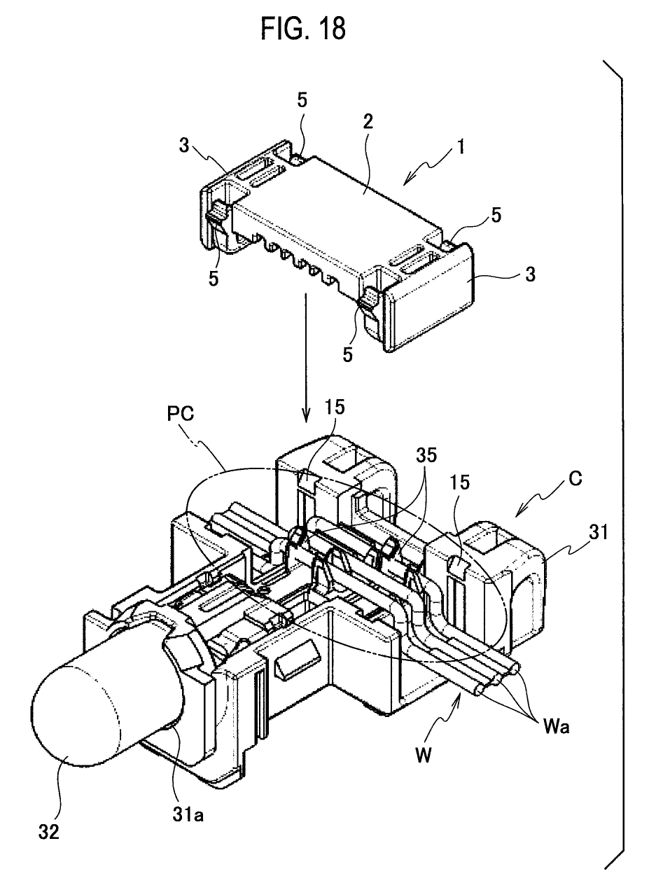

FIG. 10 is a perspective view showing a structure of an electric wire protecting cover which is provided in such a way as to be common to the three types of functional sections. FIG. 11 is a perspective view showing a structure of the backside of the electric wire protecting cover. FIGS. 12 to 14 show a structure of a first type of functional section A. FIGS. 15 to 17 show a structure of a second type of functional section B. FIGS. 18 to 20 show a structure of a third type of functional section C.

As shown in FIGS. 10 and 11, only one type of electric wire protecting cover 1 is provided in such a way as to be common to the mutually-different types of functional sections A, B, and C. This electric wire protecting cover 1 is almost rectangular, and is symmetrical with respect to the center line extending in the width direction and with respect to the center line extending in the longitudinal direction. The electrical wire protecting cover includes: a base board 2 located in the center; end walls 3 located in the two sides in the longitudinal direction; flexible lock parts 5 arranged in the respective concave parts 4 secured between the base board 2 and each end wall 3. In addition, as shown in FIG. 11, electric wire holding parts 6 are formed in an inner surface side of the electric wire protecting cover 1. Each electric wire holding part 6 curves the electric wires, and thereby generating a locking force so that each electric wire is locked against tensile forces. Each electric wire holding part 6 is almost rectangular, and is concave. In the case of the present embodiment, four electric wire holding parts 6 are provided.

As shown in FIGS. 10 and 11, notches 41 are formed in a wall part located on each longer side of each electric wire holding part 6. Projections 37 (Protrusions 37) and projections 39 (protrusions 39) are formed in a wall part located on each longer side of each electric wire holding part 6 by forming the notches 41 therein. The projections 37 are large ones, and the projections 39 are small ones. The large projections 37 and the small projections 39 are alternately arranged along each longer side of each electric wire holding part 6. Multiple rows, each having five large projections 37 arranged along the shorter sides of the electric wire holding parts 6, and multiple rows, each having five small projections 39 arranged along the shorter sides of the electric wire holding parts 6, are alternately arranged.

As shown in FIGS. 12 to 14, the first type of functional section A is a functional section with a push switch for a well base bulb. The first type of functional section A includes: a functional section main body 11 including functional part attachment portions 11a, 11b and an electric wire press-contacting part (electric wire connecting part) PA, the functional part attachment portions 11a, 11b being those with which respective functional parts including a wedge base bulb 12 and a witch unit (switch) 13 are attached to the functional section main body 11, and the electric wire press-contacting part PA being that with which electric wires Wa of a wire harness W are connected to the functional section main body 11 by press-contact (pressure-contact); the functional parts including the wedge base bulb 12 and the switch unit 13 attached to the respective functional part attachment portions 11a, 11b placed on the functional section main body 11; and an electric wire protecting cover 1 configured to cover the electric wire press-contacting part PA after the electric wires Wa are connected to the electric wire press-contacting part PA, and thereby to protect connected portions of the respective electric wires Wa.

The wire harness W in this embodiment includes a plurality of electric wires Wa. As shown in FIGS. 12 to 20, each of the electric wires Wa are joined each other by wire joining isolation portions located between the plurality of electric wires Wa. When the cover 1 is fitted into the electric wire press-contacting part PA so as to cover the electric wire press-contacting part PA after the electric wires Wa are connected to the electric wire press-contacting part PA, the large projections 37 and the small projections 39 push the wire joining isolation portions toward the electric wire press-contacting part PA. According to results by the pushing operations, the wire harness W and the plurality of electric wires Wa are fitted into the electric wire press-contacting part PA in stabilized state. In the state where cover 1 is fitted into the electric wire press-contacting part PA, each of press-contacting blades 35 provided at the electric wire press-contacting part PA (described hereinafter) are located in the notches 41 formed between the large projections 37 and the small projections 39 of the cover 1. These pushing operations and the results by the large projections 37 and the small projections 39 of the cover 1 is applied to the wire joining isolation portions located between the plurality of electric wires Wa which are fitted into electric wire press-contacting parts PB (shown in FIGS. 15 to 17) and PC (shown in FIGS. 18 to 20), described as following other embodiments hereinbelow.

As shown in FIGS. 15 to 17, the second type of functional section B is a functional section with a push switch for a boat bulb. The second type of functional section B includes: a functional section main body 21 including functional part attachment portions 21a, 21b and an electric wire press-contacting part (electric wire connecting part) PB, the functional part attachment portions 11a, 11b being those with which respective functional parts including a boat bulb 22 and a witch unit (switch) 23 are attached to the functional section main body 21, and the electric wire press-contacting part PB being that with which the electric wires Wa of the wire harness W are connected to the functional section main body 21 by press-contact (pressure-contact); the functional parts including the boat bulb 22 and the switch unit 23 attached to the respective functional part attachment portions 21a, 21b placed on the functional section main body 21; and the electric wire protecting cover 1 configured to cover the electric wire press-contacting part PB after the electric wires Wa are connected to the electric wire press-contacting part PB, and thereby to protect the connected portions of the respective electric wires Wa.

As shown in FIGS. 18 to 20, the third type of functional section C is a switchless functional section for a wedge base bulb. The third type of functional section C includes: a functional section main body 31 including functional part attachment portion 31a and an electric wire press-contacting part (electric wire connecting part) PC, the functional part attachment portion 31a being that with which a functional part such as a wedge base bulb 32 is attached to the functional section main body 31, and the electric wire press-contacting part PC being that with which the electric wires Wa of the wire harness W are connected to the functional section main body 31 by press-contact (pressure-contact); the functional parts such as the wedge base bulb 32 attached to the functional part attachment portion 31a placed on the functional section main body 31; and the electric wire protecting cover 1 configured to cover the electric wire press-contacting part PC after the electric wires Wa are connected to the electric wire press-contacting part PC, and thereby to protect the connected portions of the respective electric wires Wa.

The three different types of functional section main bodies 11, 21, 31 constituting the three types of functional sections A, B, C are those which are selected from a selection group for which the three different types of functional section main bodies are provided, respectively. For each of the three different types of functional section main bodies 11, 21, 31, the corresponding functional parts are provided. Thus, the corresponding functional parts are attached to each of the three different types of functional section main bodies 11, 21, 31. Thereby, the three types of functional sections A, B, C are configured.

The electric wire press-contacting parts PA, PB, PC of the three types of functional section main bodies 11, 21, 31 have their locking counterparts corresponding to the respective lock parts of the single type of electric wire protecting cover 1. Their locking counterparts thereof are common among the electric wire press-contacting parts PA, PB, PC. Chief elements of their locking counterparts corresponding thereto, common lock parts (lock means) 15 are provided. Each lock part 15 is configured to position and thus fix the electric wire protecting cover 1 to the lock part 15. Although these lock parts 15 need not have completely the same structure, the lock parts 15 are configured to be capable of engaging with the respective lock parts 5 of the common electric wire protecting cover 1. Similarly, the multiple press-contacting blades 35 are provided to each of the electric wire press-contacting parts PA, PB, PC. The specifications (arrangements) of the respective press-contacting blades 35 are unified among all the types of functional section main bodies 11, 21, 31.

The electric wire protecting cover 1 is of the single type capable of being commonly attached to the different types of functional section main bodies 11, 21, 31 according to common assembling relationships, as described above. For this reason, the onboard interior lighting system according to the present embodiment makes it possible to manage the parts easily, and to reduce the costs. In addition, the system no longer causes a wrong type of electric cable protecting cover to be attached to any one of the different types of functional section main bodies. In addition, because the system causes only the single type of electric wire protecting cover 1 to be supplied instead of multiple types of electric wire protecting covers when the system is assembled up, the system enables a part feeder to supply electric wire protecting covers of the single type through its automated operation, and accordingly to enhance the productivity.

The onboard interior lighting system according to the present embodiment makes it possible to attach the electric wire protecting cover 1 to any one of the functional section main bodies 11, 21, 31 with no attention required to be paid to the orientation of the electric wire protecting cover 1, because the electric wire protecting cover 1 is formed almost rectangular in such a way as to be symmetrical with respect to the center line extending in the width direction and with respect to the center line extending in the longitudinal direction. Accordingly, the system can enhance the assemblage performance. In addition, the onboard interior lighting system can simplify a part feeder in a case where the part feeder supplies the electric wire protecting cover 1 through its automated operation, because the electric wire protecting cover 1 has no orientation.

Since specifications (arrangements) of the respective press-contacting blades 35 in each of the electric cable connectors are unified among all the types of functional section main bodies 11, 21, 31, the onboard interior lighting system of the embodiment according to the present invention makes it possible to unify the methods of press-contacting the electric wires to the press-contacting blades which methods would otherwise be different from one another depending on the difference among the press-contacting blades into the single method, and to unify the apparatuses for press-contacting the electric wires to the press-contacting blades which apparatuses would otherwise be different from one another depending on the difference among the press-contacting blades into a single apparatus. In addition, the system makes it possible to enhance the productivity.

The onboard interior lighting system according to the present embodiment enables the electric wire protecting cover 1 to be commonly attached to any one of the different types of functional section main bodies 11, 21, 31 only by locking the lock parts 5 of the electric wire protecting cover 1 to the lock parts 15, because the electric wire press-contacting parts PA, PB, PC of the different types of functional section main bodies 11, 21, 31 have their common lock parts 15 as their common locking counterparts corresponding to the respective lock parts 5 of the electric wire protecting cover 1 of the single type.

The present invention is not limited to the above-description and the above-described embodiments, and may be embodied in various different forms by making appropriate modifications thereto.

It should be noted that the entire content of Japanese Patent Application No. 2008-011588 (filed on Jan. 22, 2008) is incorporated herein by reference.

What is claimed is:

1. An onboard interior lighting system, comprising:
a functional section main body comprising: functional part attachment portions; and an electric wire connecting part for connecting electric wires with the functional section main body;
functional parts including a bulb and a switch, the functional parts configured to be respectively attached to the functional part attachment portions on the functional section main body;
an electric wire protecting cover configured to cover the electric wire connecting part after the electric wires are connected to the electric wire connecting part, and thereby to protect connected portions of the respective electric wires; and
a functional section arranged on an exterior side of a ceiling board of a vehicle, wherein
the functional section main body is one selected from a selection group for which a plurality of mutually-different types of functional section main bodies are provided,
the functional parts corresponding to the selected functional section main body are attached to the functional section main body,
the electric wire protecting cover is of only a single type provided commonly for the mutually-different types of functional section main bodies; and
a single type of the electric wire protecting cover has its common assembling relationships with each type of the electric wire connecting parts among variable type of the electric wire connecting parts.

2. The onboard interior lighting system according to claim 1, wherein the common assembling relationships of the electric wire connecting part of each type of functional section main body includes common lock means to locate the electric wire protecting cover of the single type so as to fit to the each type of functional section main body.

3. The onboard interior lighting system according to claim 1, wherein
the electric wire protecting cover has an almost rectangular shape; and
the electric wire protecting cover has a plurality of protrusions which are arranged so as to be located symmetrically with respect to a center line extending in a width direction and with respect to a center line extending in a longitudinal direction of the electric wire protecting cover.

4. The onboard interior lighting system according to claim 2, wherein
the electric wire protecting cover has an almost rectangular shape; and
the electric wire protecting cover has a plurality of protrusions which are arranged so as to be located symmetrically with respect to a center line extending in a width direction and with respect to a center line extending in a longitudinal direction of the electric wire protecting cover.

5. The onboard interior lighting system according to claim 1, wherein
the electric wire connecting part includes a plurality of press-contacting blades, and is thus configured as an electric wire press-contacting part of a type which press-contacts the electric wires to the press-contacting blades; and
the arrangements of the respective press-contacting blades of the electric wire press-contacting part are unified through all the types of functional section main bodies.

6. The onboard interior lighting system according to claim 2, wherein
the electric wire connecting part includes a plurality of press-contacting blades, and is thus configured as an electric wire press-contacting part of a type which press-contacts the electric wires to the press-contacting blades; and
the arrangements of the respective press-contacting blades of the electric wire press-contacting part are unified through all the types of functional section main bodies.

7. The onboard interior lighting system according to claim 3, wherein
the electric wire connecting part includes a plurality of press-contacting blades, and is thus configured as an electric wire press-contacting part of a type which press-contacts the electric wires to the press-contacting blades; and
the arrangements of the respective press-contacting blades of the electric wire press-contacting part are unified through all the types of functional section main bodies.

8. The onboard interior lighting system according to claim 4, wherein
the electric wire connecting part includes a plurality of press-contacting blades, and is thus configured as an electric wire press-contacting part of a type which press-contacts the electric wires to the press-contacting blades; and
the arrangements of the respective press-contacting blades of the electric wire press-contacting part are unified through all the types of functional section main bodies.
